(19) United States
(12) Patent Application Publication
(10) Pub. No.: US 2011/0296845 A1
(43) Pub. Date: Dec. 8, 2011

(54) Combined heat and power with a peak temperature heat load

(76) Inventor: Jonathan Jay Felnstein, North Salem, NY (US)

(21) Appl. No.: 13/136,322

(22) Filed: Jul. 28, 2011

Related U.S. Application Data
(63) Continuation-in-part of application No. PCT/US10/00258, filed on Jan. 28, 2010.
(60) Provisional application No. 61/206,130, filed on Jan. 28, 2009.

(51) Int. Cl. F02C 6/18; F02C 3/04; F02C 7/00; F02C 3/14

(52) U.S. Cl. 60/783; 60/722; 60/805; 60/784; 60/39.12

(57) ABSTRACT

A combined heat and power plant in which air is compressed in a compressor, the compressed air is reacted with a fuel, producing high temperature, high pressure combustion products, the combustion products heat a first heat load whereby the combustion products are cooled to a temperature suitable for entry into an expander, and the cooled, high pressure combustion products are expanded in the expander which provides turning power to a power load such as a generator. Less than substantially 200% excess air and preferably less than substantially 20% excess air is compressed. The exhaust gas from the expander may optionally heat a second heat load. The first heat load may be the heating of a hydrocarbon and steam to promote steam methane reforming to form syngas. The second heat load may be a combination of boiling steam for reforming a hydrocarbon and heating a building or the like.

### CROSS-REFERENCE TO RELATED APPLICATIONS

This application is a continuation-in-part of P.C.T Application Number PCT/US10/00258 (Docket #93-2), entitled, “COMBINED HEAT AND POWER WITH A PEAK TEMPERATURE HEAT LOAD,” filed Jan. 28, 2010, by Jonathan Jay Feinstein, which claims priority benefit of U.S. Provisional Application Ser. No. 61/206,130 (Docket #93-1) filed Jan. 28, 2009, by Jonathan Jay Feinstein, which are both incorporated herein by reference.

### FIELD OF INVENTION

This invention is in the field of power generation.

### DEFINITIONS

SMR is the abbreviation of either steam methane reforming or steam methane reformer, depending on the context of its usage.

Air as used herein is exemplary of a fluid containing free oxygen molecules such as air, oxygen, and mixtures thereof.

The percentage excess air is defined as the mass of air or oxidant provided for combustion of a fuel divided by the stoichiometric mass of the air or oxidant to completely combust the fuel minus one hundred percent.

A process heater is defined as a unit in which air and a fuel are combusted to heat a load. Examples include any form of industrial, commercial or residential combustion furnace.

### BACKGROUND

Power generation, particularly electrical power generation, often involves use of a turbine to expand a working fluid such as combustion products and dilution air at high temperature and pressure. To the extent air is adiabatically compressed to higher pressures, the air reaches higher temperatures at the compressor outlet, potentially resulting in higher adiabatic flame temperatures, and necessitating higher percentages of excess air as a countermeasure to dilute the flame temperature to temperatures compatible with the materials of construction of the combustor and turbine. Gas turbines typically compress and expand approximately three to four times as much air as is needed to fully combust the fuel or 200% to 300% excess air. This lean combustion is necessary to dilute the flame temperature in the combustion chamber to temperatures the combustor and turbine can withstand without premature failure, but results in an exhaust gas stream from the turbine of high energy content relative to products of stoichiometric combustion at the same turbine exhaust temperature. Higher percentages of excess air are required for flame temperature dilution at higher compressor outlet temperatures.

The temperature of products of combustion closer to a stoichiometric ratio can alternatively and more economically be reduced by using the combustion products to heat a load, such that less dilution air is required to cool the combustion products to temperatures acceptable for expansion in a turbine. By passing less dilution air through a turbine the heat content of the expanded effluent gas of a given outlet temperature is reduced. Further, by reducing the volume of the effluent from the turbine for a given amount of combustion, the concentration of carbon dioxide in the outlet stream is increased, making decarbonization of the effluent less expensive per unit of CO₂ mass removed.

A chemical process heater often consists of a large combustion furnace which heats a process fluid flowing through tubes within the furnace. Because combustion is normally performed at atmospheric pressure in these furnaces, the furnaces are larger and more expensive and have higher surface area for heat losses than if combustion were performed at elevated pressure.

Process heaters lose sensible heat in the form of hot combustion product effluent or flue gas. Methods of reducing this energy loss include oxygen enrichment of the combustion air to lower the thermal mass of the flue gas.

For example, hydrogen is economically produced by SMR's, which include the expensive components of the radiant zone and convective zones of the reformer. Fuel and atmospheric pressure air combust in the radiant zone to heat methane and steam flowing through tubes within the furnace to temperatures at which the steam and methane endothermically react to form hydrogen. After the combustion products have transferred heat such that the combustion products cool and are less effective for radiant heat transfer, they pass through a convective zone in which they flow over tubes containing process fluids such as steam and methane to heat those fluids convectively to intermediate temperatures. Further, the large volumes of the radiant and convective zones to contain combustion at atmospheric pressure may require so much space as to preclude decentralized production of power or hydrogen in locations of highest demand.

Heating process fluids at high pressure inside tubes within a furnace at atmospheric pressure requires thick walled tubes which are expensive and which because of their thickness limit the desired heat transfer through the tube walls. By performing combustion at elevated pressure, thinner walled and/or larger diameter tubes can be used and/or the tubes can be operated at higher pressure or at higher temperatures at which the conversion of methane to hydrogen is more complete.

In some process heaters, as in SMR's, the heat contained in the flue gases may exceed local thermal requirements to preheat process fluids and/or combustion air. The surplus heat in conventional SMR flue gas is often used to raise steam for export, but in cases where there is no local demand for the steam or any other form of the surplus heat, that surplus heat may have little or no economic value.

Further, a large part of the cost of electricity derives from transmitting and distributing the power from where it is generated to where it is used, costs that are obviated by decentralized power production. SMR plants often require power to compress hydrocarbon feedstock, such as methane, and to compress the product hydrogen, especially to the high pressures in excess of 500 bar suitable for transportation applications. Local generation of that power without transmission and distribution costs would be advantageous.

Steam methane reforming is a known method of decarbonizing natural gas to form hydrogen. Carbon dioxide is highly concentrated in SMR effluent, rendering the contained CO₂ relatively inexpensive to isolate and sequester.

### PRIOR ART

Operation and configuration of SMR's and other process heaters are known. Operation and configuration of natural gas fired power plants with gas turbines are known.

Combined heat and power plants are known in which the exhaust heat from a gas turbine is used to provide relatively low temperature heat for some commercially useful purpose other than the production of the electric power. Use of the exhaust heat from a gas turbine to supply heat to an SMR is known as taught in U.S. Pat. No. 6,338,239. Use of hydrogen from an SMR as fuel to a gas turbine is known as taught in U.S. Pat. No. 6,923,004. Integration of an electric power plant and an SMR is taught in U.S. patent application Ser. No. 12/048,805 Publication Number 2009/0229239.

### BRIEF DESCRIPTION OF DRAWINGS

FIG. 1 is a schematic view of the present invention.

FIG. 2 is a schematic view of the present invention according to another embodiment.

FIG. 3 is a schematic view of the present invention according to another embodiment.

### DETAILED DESCRIPTION OF THE INVENTION

The following detailed description discloses various exemplary embodiments and features of the invention. These exemplary embodiments and features are not meant to be limiting.

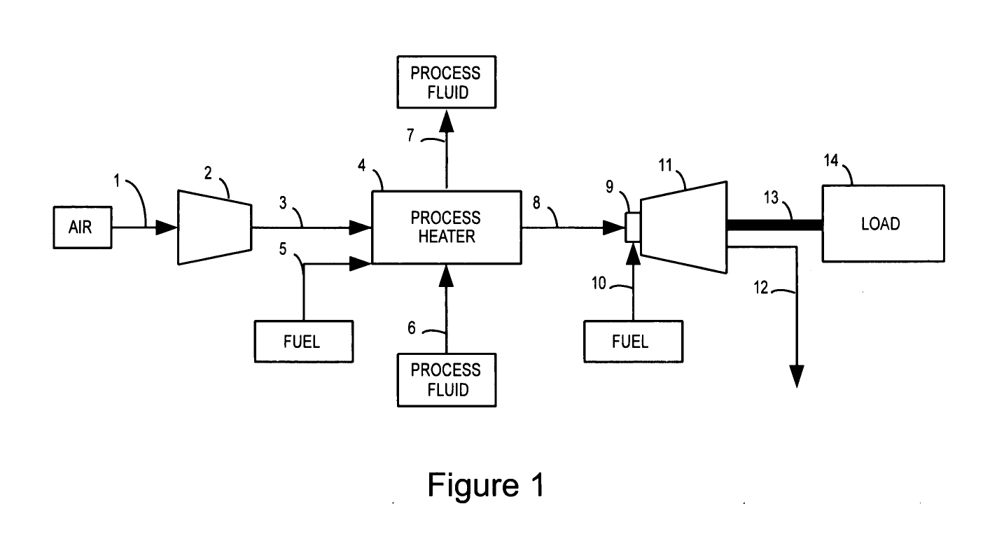

Referring to FIG. 1, air, preferably at atmospheric pressure, is conveyed via optional conduit or line 1 to one or more compressors 2 wherein the air is compressed. Multiple compressors if used, not shown, are preferably arranged in series with inter-cooling with an external coolant or with adiabatic cooling of the air and a liquid such as water, wherein the water is vaporized into the air, causing the air to be cooled and wherein the total heat content of the air and water is substantially unchanged by the direct evaporative heat exchange between the air and water. The compressors are preferably centrifugal compressors. The compressed air is conveyed from the one or more compressors to process heater 4 via line 3. Fuel is conveyed via line 5 to process heater 4 wherein the fuel and compressed air combust to provide heat to a load, preferably a process fluid. The process fluid is conveyed via line 6 to the process heater wherein the process fluid is heated by heat from the combustion gases. Process fluid is conveyed from the heater via line 7.

The process fluid may undergo a chemical reaction within the heater. The reaction may be endothermic or exothermic and may be promoted by a catalyst. The process fluid is separated from the combustion gases, such as by tubing or other form of a solid wall wherein the process fluid flows from line 6 to line 7 through one or more tubes in the heater and wherein the combustion products flow from line 3 to line 8 via at least part of the volume surrounding the one or more tubes containing process fluid in the heater. Alternatively, the combustion gases could be conveyed through the heater via one or more tubes and the process fluid could flow around the tubes within the heater. Other configurations of indirect heat exchanger are possible such as plate or concentric cylindrical heat exchange surfaces. Combustion gases exit the heater via line 8 through which they are conveyed to optional combustion chamber or burner 9 or directly to one or more expanders 11.

Carbon dioxide may be removed from the combustion gases between the process heater and expander. Multiple process heaters may be used in series and/or in parallel through which air from one or more compressors in series or in parallel is combusted to transfer heat to a load within the process heaters. In the case that a load is heated that is a solid and not a process fluid, the process heater must contain gas tight doors for respectively charging the load to and discharging the load from the heater, whether via lines 6 and 7, respectively, or without lines 6 or 7, and the load may be in direct contact with the combustion gases for direct transfer of heat from the combustion gases to the load.

The expanders are preferably turbo expanders. Fuel may optionally be conveyed by line 10 to optional combustion chambers 9 in which the fuel is combusted with the combustion gas from line 8 before entering the expanders. The gas entering the expander preferably contains a minimum of excess oxygen to assure adequate combustion of oxidizable pollutants such as hydrocarbons and carbon monoxide. The said minimal oxygen content is preferred to higher excess oxygen content to minimize heat content of the effluent from the expander for a given amount of combustion fuel consumed. At least about as much air is compressed as is needed for complete combustion of the fuel. The excess air compressed for combustion is less than substantially 200%, is more preferably less than substantially 150%, is yet more preferably less than substantially 100% and is most preferably less than substantially 20%. The target expander inlet temperature is preferably the maximum temperature compatible with the reliable operation of the expander, which is often in the range of 800° to 1300° C. The last compressor outlet pressure is greater than 3 bar, is preferably greater than 10 bar and is most preferably greater than 20 bar.

The amount of heat transferred to the load in the process heater is preferably adequate to cool the combustion gases to a temperature less than or equal to the target expander inlet temperature and is also preferably convenient to the heating purposes of the process heater. The temperature and transfer of heat from the combustion gases in the process heater is also convenient to the efficient heat exchange purposes of the heater without overheating components of the heater such as the heat transfer surfaces. To avoid overheating the heat transfer surfaces and yet transfer sufficient heat to the load as is convenient to the purposes of the process heater the temperature of the combustion gases exiting the process heater may be lower than the target expander inlet temperature, in which case it is preferable to compress more air in the compressors than is needed for stoichiometric combustion within the heater and preferable to add fuel via line 10 to burners 9 to raise the combustion gas temperature to the target expander inlet temperature with as little as possible excess oxygen content after combustion in the last burner 9. Combustion gas exits the expander at reduced temperature and pressure via line 12. Shaft 13 is attached to the expander and to a load 14 to transfer rotational power to the load. The load may be an electric generator, one or more of the compressors in combination needed to compress fuel, air, process fluid, or product hydrogen from an SMR or could comprise any other device in which the power may be advantageously used.

The combustion gases in line 12 may be decarbonized by any method, not shown, of CO₂ removal from that gas stream. If the gases exiting the expander in a single pass operation would contain substantial amounts of free oxygen without recirculation, such as more than 5% by volume, some of the combustion gases in line 12 may be recirculated directly or indirectly to the inlet of compressors 2 and the remainder of the combustion gases in line 12 may be decarbonized by any method. In this recirculation practice the relative amounts of gases recirculated versus being decarbonized should be preferably such that the excess oxygen content is reduced to the minimum amount necessary for substantially complete combustion of hydrocarbons and carbon monoxide from the gases in line 12, which correspondingly provides a desirable concentration of CO₂ in the effluent stream for decarbonization with minimally sized equipment.

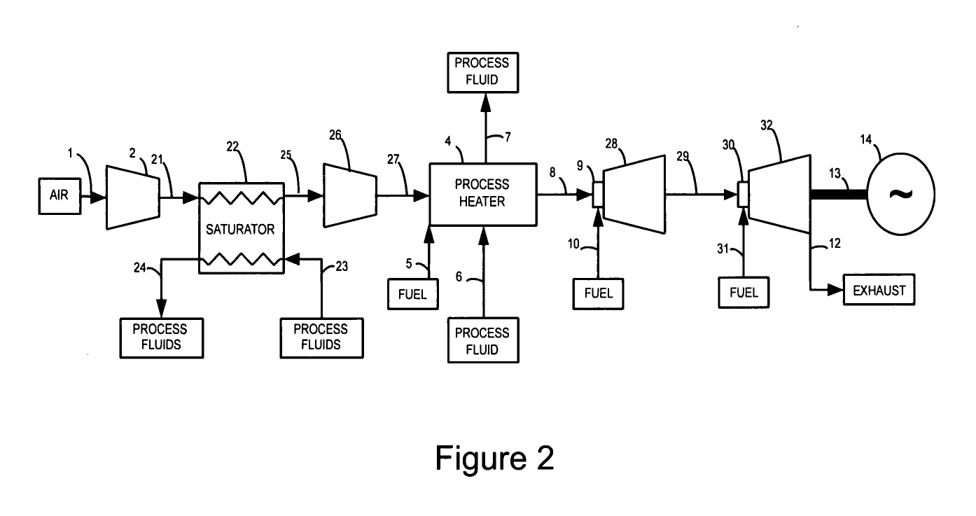

All numbers used in both FIGS. 1, 2, and 3refer to like components of the respective figures. Referring to FIG. 2, air is conveyed via optional conduit or line 1 to compressor 2 wherein the air is compressed. Line 21 conveys the compressed air to saturator 22 wherein the air is cooled against liquid and gaseous process fluids, wherein the liquid fluid is preferably water, which is raised to steam within the gaseous process fluid to saturate the gaseous fluid with steam. The process fluids are conveyed to the saturator via line 23 and exit the saturator via line 24. The cooled air is conveyed via line 25 from the saturator to compressor 26, wherein the air is further compressed. The compressed air is conveyed from compressor 26 to process heater 4 via line 27. Fuel is conveyed via line 5 to process heater 4 wherein the fuel and compressed air combust to provide heat to a load, preferably a process fluid. The process fluid is conveyed via line 6 to the process heater wherein the process fluid is heated by heat from the combustion gases. Process fluid is conveyed from the heater via line 7.

Combustion gases exit the process heater via line 8 through which they are conveyed to combustion chamber or burner 9 and from burner 9 to expander 28. Fuel is conveyed by line 10 to burner 9 in which the fuel is combusted with the combustion gas from line 8 before entering expander 28. The air is partially expanded in expander 28 and exits expander 28 via line 29 to burner 30. Fuel is conveyed via line 31 to burner 30 wherein the fuel and air combust. The reheated gas passes from burner 30 to one or more expanders 32 arranged in series to each other wherein the air is more fully expanded. The effluent exits the last expander 32 via line 12. Shaft 13 transmits turning energy from at least one expander to load 14, which may be an electric generator or compressor.

The gas inlet and outlet temperatures of each expander are designed to maximize the amount of power performed by the series of expanders without exceeding the temperature limits of the materials of construction. Heat exchangers, not shown, may be used to reheat the gas between the expanders. Alternatively, the heat exchanger for reheating the partially expanded gases is the process heater 4 of FIG. 2

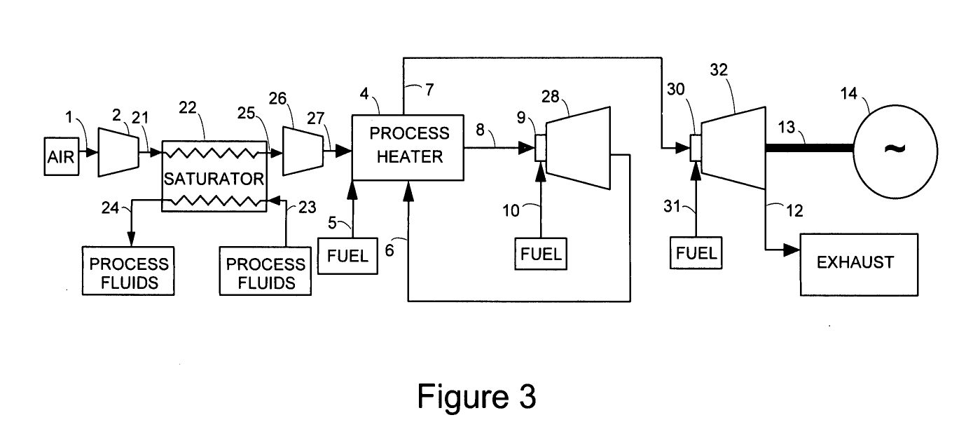

Referring to FIG. 3, air is conveyed via optional conduit or line 1 to compressor 2 wherein the air is compressed. Line 21 conveys the compressed air to saturator 22 wherein the air is cooled against liquid and gaseous process fluids, wherein the liquid fluid is preferably water, which is raised to steam within the gaseous process fluid to saturate the gaseous fluid with steam. The process fluids are conveyed to the saturator via line 23 and exit the saturator via line 24. The cooled air is conveyed via line 25 from the saturator to compressor 26, wherein the air is further compressed. The compressed air is conveyed from compressor 26 to process heater 4 via line 27. Fuel is conveyed via line 5 to process heater 4 wherein the fuel and compressed air combust to provide heat to the load. In contrast to the FIG. 2 embodiment, in the FIG. 3 embodiment, the process fluid is conveyed via line 6 to the process heater wherein the process fluid is heated by heat from the combustion gases. Process fluid is conveyed from the heater via line 7.

Combustion gases exit the process heater via line 8 through which they are conveyed to combustion chamber or burner 9 and from burner 9 to expander 28. Fuel is conveyed by line 10 to burner 9 in which the fuel is combusted with the combustion gas from line 8 before entering expander 28. The air is partially expanded in expander 28 and exits expander 28 via line 6 to the process heater as the load that is heated within the process heater. The reheated air is conveyed from the process heater via line 7 to burner 30. Fuel is conveyed via line 31 to burner 30 wherein the fuel and air combust. The reheated gas passes from burner 30 to one or more expanders 32 arranged in series to each other wherein the air is more fully expanded. The effluent exits the last expander 32 via line 12. Shaft 13 transmits turning energy from at least one expander to load 14, which may be an electric generator or compressor.

In one embodiment the process heater is the radiant zone of an SMR in which steam and a hydrocarbon are reformed to produce a hydrogen containing outlet gas stream, often referred to as syngas. In other process units of the SMR the hydrogen is separated from the syngas, resulting in a high purity hydrogen product stream and a tail gas stream relatively rich in carbon dioxide. The hydrogen product stream is used as part or all of the fuel in at least one of lines 5 and 10 of FIG. 1 or 2. Process heater 4 is a shell and tube heat exchanger in which the combustion products pass through the shell side and steam and a hydrocarbon pass through the tube side. The tubes contain catalyst suitable for promoting the reforming reaction. The pressure of the air exiting the last compressor is about the same as the pressure in the reformer tubes. As an example, the pressure in both the shell and tubes is about 30 bar. The hydrogen product stream may be totally or partially distributed to the turbine to provide electric power during times of peak power demand and alternatively used totally or partially as transportation fuel at other times. The combined heat and power plant is located in a highly populated area such as in or near an apartment building where cars are filled with hydrogen at night to minimize the need for stationary hydrogen storage and obviate the need to drive to a remotely, located fueling station.

Although the present invention has been described in terms of certain preferred embodiments, various features of separate embodiments can be combined to form additional embodiments not expressly described. Moreover, other embodiments apparent to those of ordinary skill in the art after reading this disclosure are also within the scope of this invention. Furthermore, not all of the features, aspects and advantages are necessarily required to practice the present invention. Thus, while the above detailed description has shown, described, and pointed out novel features of the invention as applied to various embodiments, it will be understood that various omissions, substitutions, and changes in the form and details of the apparatus or process illustrated may be made by those of ordinary skill in the technology without departing from the spirit of the invention. The inventions may be embodied in other specific forms not explicitly described herein. The embodiments described above are to be considered in all respects as illustrative only and not restrictive in any manner. Thus, scope of the invention is indicated by the following claims rather than by the foregoing description.

I claim:

1. A combined heat and power plant comprising
a. a compressor in which air is compressed,
b. a process heater in which a fuel is combusted with the compressed air to heat a heat load, resulting in cooled, high pressure combustion products, and
c. an expander suitable for transmitting power to a power load in which the cooled, high pressure combustion products are expanded in which less than 200% excess air is compressed.

2. The plant of claim 1 in which less than 150% excess air is compressed.

3. The plant of claim 1 in which less than 100% excess air is compressed.

4. The plant of claim 1 in which less than 20% excess air is compressed.

5. The plant of claim 1 in which the expander is a turbo expander.

6. The plant of claim 1 in which the expander is a gas turbine in which fuel is combusted with the cooled, high pressure combustion products, and wherein the excess air is that associated with the combustion in both the process heater and gas turbine.

7. The plant of claim 1 in which the high pressure combustion products are cooled to a temperature between 800° and 1300° C. in the process heater.

8. The plant of claim 1 in which exhaust gas exits the expander and the exhaust gas is used to heat a second heat load.

9. The plant of claim 8 in which the second heat load is one of a building and a process fluid.

10. The plant of claim 9 in which the second heat load is boiler feed water and the exhaust gas is used to boil the water.

11. The plant of claim 1 in which the compressor is a multistage compressor with intermediate cooling of the compressed air against a second heat load.

12. The plant of claim 1 in which the process heater is a steam methane reformer and the heat load includes the heat of reaction of the endothermic reforming reaction of steam and a hydrocarbon to form a hydrogen containing gas.

13. A process for providing heat and power comprising
a. compressing air in a compressor,
b. combusting the compressed air with a fuel to heat a heat load in a process heater, resulting in cooled, high pressure combustion products, and
c. expanding the cooled, high pressure combustion products in an expander suitable for transmitting power to a power load in which less than 200% excess air is compressed.

14. The process of claim 13 in which less than 150% excess air is compressed.

15. The process of claim 13 in which less than 100% excess air is compressed.

16. The process of claim 13 in which less than 20% excess air is compressed.
